(19) United States
(12) Patent Application Publication
(10) Pub. No.: US 2017/0242475 A1
(43) Pub. Date: Aug. 24, 2017

(54) METHOD AND SYSTEM FOR REDUCING POWER CONSUMPTION IN BITCOIN MINING VIA WATERFALL STRUCTURE

(71) Applicant: SPONDOOLIES TECH LTD., Kiryat Gat (IL)

(72) Inventors: Assaf GILBOA, Rehovot (IL); Zvi SHTEINGART, Jerusalem (IL); Kobi LEVIN, Rishon le-Zion (IL); Guy COREM, Netanya (IL)

(21) Appl. No.: 15/521,619

(22) PCT Filed: Oct. 29, 2015
(86) PCT No.: PCT/IL2015/051060

§ 371 Date: Apr. 25, 2017

Related U.S. Application Data
(60) Provisional application No. 62/072,466, filed on Oct. 30, 2014.

(51) Int. Cl. G06F 1/32; G06Q 20/06; G06Q 20/36; H04L 9/06

(52) U.S. Cl. CPC G06F 1/3287; H04L 9/0643; G06F 1/3237; G06F 1/324; G06Q 20/065; G06Q 20/3672

(57) ABSTRACT

A method and engine for hash calculation, the method comprising receiving data blocks via an input module, providing clock cycles by a clock module, calculating a hash from a received data block by a process module including a data pipeline and a state pipeline, the hash calculation comprising: an input data block to the data pipeline, the data block includes a sequence of data words including X data words, wherein X is a known number, calculating, in every other clock cycle of the clock module, an new data word based on the last calculated X data words, and performing a stage of the state pipeline in each clock cycle of the clock module, in which a state is calculated based on input from the data pipeline, the input includes the last calculated X data words, and outputting the hash via an output module every predetermined number of clock cycles.

### CROSS REFERENCE TO RELATED APPLICATIONS

This application claims the benefit of U.S. provisional patent application No. 62/072,466, filed on Oct. 30, 2014 which is incorporated herein by reference in its entirety.

### FIELD OF THE INVENTION

The present invention relates to implementing bitcoin block chain signing, and more particularly, to implementing same in an efficient engine micro architecture which uses data processing technique to support reduced power consumption.

### BACKGROUND OF THE INVENTION

The most important part of the bitcoin system is a public ledger that records financial transactions in bitcoins. This is accomplished without the intermediation of any single, central authority, as long as mining is decentralized. Instead, multiple intermediaries exist in the form of computer servers running bitcoin software. By connecting over the Internet, these servers form a network that anyone can join. Transactions of the form: “payer X wants to send Y bitcoins to payee Z” are broadcasted to this network using readily available software applications. Bitcoin servers can validate these transactions, add them to their copy of the ledger, and then broadcast these ledger additions to other servers.

Bitcoin transactions are permanently recorded in a public distributed ledger called the block chain. Approximately six times per hour, a group of accepted transactions, a block, is added to the block chain, which is quickly published to all network nodes. This allows bitcoin software to determine when a particular bitcoin amount has been spent, a novel solution for preventing double-spends in a peer-to-peer environment with no central authority. Whereas a conventional ledger records the transfers of actual bills or promissory notes that exist apart from it, the block chain is the only place that bitcoins can be said to exist. To independently verify the chain-of-ownership of any and every bitcoin amount, full-featured bitcoin software stores its own copy of the block chain.

Maintaining the block chain is referred to as “mining” and those who do that are rewarded with newly created bitcoins and transaction fees. Miners may be located anywhere in the world; they process payments by verifying each transaction as valid and adding it to the block chain. Today, payment processing is rewarded with 25 newly created bitcoins per block added to the block chain. To claim the reward, a special transaction called a coinbase is included with the processed payments. All bitcoins in circulation can be traced back to such coinbase transactions. The bitcoin protocol specifies that the reward for adding a block will be halved approximately every four years. Eventually, the reward will be removed entirely when an arbitrary limit of 21 million bitcoins is reached circa 2140, and transaction processing will then be rewarded by transaction fees solely.

Recently, mining has become very competitive, and ever more specialized technology is utilized. The most efficient mining hardware makes use of custom designed application-specific integrated circuits (ASIC), which outperform general purpose CPUs and use less power as well. Without access to these purpose built machines, a bitcoin miner is unlikely to earn enough to even cover the cost of the electricity used in his or her efforts.

Bitcoin chain block consists of transactions that need to be executed that are preceded by header. All the transactions are signed using a Merkle Tree implementation and the signature is embedded in the block header, the block header also needs to be signed by double hash that meets certain conditions in order to become a valid signature that is accepted by the network.

A Merkle tree is a binary tree that is used in bitcoin to summarize all the transactions in a block, producing an overall digital fingerprint of the entire set of transactions. A Merkle tree is constructed by recursively hashing pairs of nodes until there is only one hash, called the root, or Merkle root.

A bitcoin block chain holds the actual transactions and is signed by signing the transactions and the header. The header is the heart of all the bitcoin mining mechanism and is used in order to secure the bitcoin by design as well as driving bitcoin mining efforts.

The mining algorithm for Bitcoins is done by signing the header of each message. Every miner gets a header to sign from a pool which distributes headers to a group of miners. The miner needs to perform the following Hash function in order to find a signature of the header as shown in Equation 1 below:

Signature=SHA-256(SHA-256(Block_Header)) Eq. (1)

The function SHA256 produces a hash with 256 bits. After finding the signature, the miner can know if the header is a valid header and can be sent to the network as a successful transaction. There are very rare cases where the header is valid.

A header is valid only when the signature is smaller than the Target (Bits) in the header. The target is a 256-bit number (extremely large) that all Bitcoin clients share. The SHA-256 hash of a block's header must be lower than or equal to the current target for the block to be accepted by the network. The lower the target, the more difficult it is to generate a block.

The header includes the following fields: version, previous block hash, Merkle root, timestamp, bits and nonce. SHA-256 is calculated over chunks of 512 bits. The block header can be divided to two chunks adding a padding field of 384b. The first chunk (Chunk 1) includes the version, the previous block hash and a main portion (for example, 224 bits out of 256 bits) of the Merkle root hash. The second chunk (Chunk 2) may include a marginal portion of the Merkle root hash (for example, 32 bits), the timestamp, bits, nonce and the padding field. The version and the padding sections are constant. The previous block hash, the timestamp and the bits sections are changed for each new block header. The Merkle root hash can be changed by the miner within a given header by influencing the Merkle root and the nonce is the dynamic portion which is scanned by the miner in order to look for the signature.

In order to find the header structure that will create a valid signature (less than the target), the miner is allowed to change the 32b nonce value. The miner can increment the nonce value for every trial and check for a signature, in order to cover all options a 2̂32 trials are needed, which may lead to no resolution and then a new header format should be attempted. (a new header format is created by using a different Merkle root that is extracted from the list of transactions in the message).

In order to focus on the hash algorithm and optimization for the nonce scanning (2̂32 iterations), we will just assume that the miner has an option to change the Merkle root and start a new round of nonce scanning using a new header structure and look for a valid signature again.

As mentioned above, the signature is calculated by applying SHA-256(SHA-256 (Header)). The first chunk is hashed first, providing the mid-state hash (H0). H0 is the initial vector (IV) that is used to load the initial state of the SHA of the second chunk which produces that intermediate result of the SHA(Header), This then goes to another SHA function that produces the signature. Therefore, the process involves three SHA iterations (each SHA iteration takes approximately 64 cycles). The mid-state H0 is calculated once per header, usually by the host computer. The next two hashes are the performance calculations and may be carried out by hardware acceleration.

As described above the transactions are signed using a Merkle root hash. The Merkle root can be manipulated by adding a coinbase transaction to the network transactions. As mentioned above, a coinbase transaction belongs to the miner and can be used to get the mining fees.

Power efficiency of the aforementioned double hash architecture plays a critical factor in the engine implementation. In known engine implementations, the engine toggles every clock and the power consumption is split between the logic and the flop flops more or less evenly. The flip flop power is dictated by the shift between stages of the engine. In the known implementations, the shift between stages happens every clock cycle and is a significant contributor to the overall power consumption, as well as the repeating data processing.

### SUMMARY OF THE INVENTION

Embodiments of the present invention may provide a method and system for reducing power consumption in bitcoin mining via waterfall structure, the system may include a hash engine, including an input module for receiving data blocks, a memory, a clock module to provide clock cycles, a process module including a data pipeline and a state pipeline for calculating a hash from a received data block, and an output module to output the hash every predetermined number of clock cycles.

The process module according to some embodiments of the present invention may be configured to receive an input data block to the data pipeline, the data block includes a sequence of data words including X data words, wherein X is a known number, calculate, in every clock cycle of the clock module, a new data word based on the last calculated X data words, and perform a stage of the state pipeline in each clock cycle of the clock module, in which a state is calculated based on input from the data pipeline, the input includes the last calculated X data words. In some embodiments of the present invention, X is equal 16, and wherein each data word is of 32 bits.

In some embodiments of the present invention, the calculated state includes a sequence of eight state words, wherein the process module is further configured to calculate, in each clock cycle, a first and fifth new state words of the sequence, in order to form a new state of sequenced eight words based of the previous state's words.

In some embodiments of the present invention, after X clock cycles, a new input data block is inserted instead of the first X data words of the previously inserted input data block.

In some embodiments of the present invention, the engine has an array arrangement, the array has X columns to which input data blocks can be inserted, wherein the engine is configured to receive a new input data blocks to another of the X columns on every clock cycle, once the first X data words in the column become irrelevant. In some embodiments of the present invention, each column may include up to four different input data blocks in process. In some embodiments of the present invention, the engine is further configured to provide to a row in said array arrangement, in each clock cycle, multiplexed values from previous rows, to demultiplex the multiplexed values in order to create a new data word in a selected column, and to generate multiplexed word values by multiplexing data words of the row, for generating new words in following rows.

In some embodiments of the present invention, the engine has an array arrangement in the state pipeline, the array has four columns, to which state sequences can be inserted, each state sequence is represented by four couples of a first and a fifth words, wherein the engine is further configured to receive a new state sequence to another of the four columns on every clock cycle, once the first four couples in the column become irrelevant. The engine may be further configured to provide to a row in said array arrangement, in each clock cycle, multiplexed values from previous rows, to demultiplex the multiplexed values in order to create a new state word in a selected column, and to generate multiplexed word values by multiplexing state words of the row, for generating new words in following rows.

### BRIEF DESCRIPTION OF THE DRAWINGS

For a better understanding of embodiments of the invention and to show how the same may be carried into effect, reference will now be made, purely by way of example, to the accompanying drawings in which like numerals designate corresponding elements or sections throughout.

In the accompanying drawings:

FIG. 1 is a schematic illustration of a SHA-256 hash engine according to embodiments of the present invention;

FIG. 2 is a schematic illustration of a state-of-the-art process for signature calculation, also called herein “the regular implementation”;

FIG. 3 is a schematic illustration of a logic circuit diagram representing the logic function that is implemented in order to create an induced data block according to embodiments of the present invention;

FIG. 4 is a schematic illustration of a logic circuit diagram representing the arithmetic logic that is used for calculating the first and fifth state words of the next state in the state pipeline.

FIG. 5 is a schematic diagram illustrating one job being processed in the data (W) section in a simple W waterfall implementation, herein referred to as a W waterfall, according to some embodiments of the present invention.

FIG. 6 is a schematic illustration of a W waterfall array, which allows a new job entry, i.e. new data input, on every cycle, rather than new data every 16 cycles when using one column, according to some embodiments of the present invention.

FIG. 7 is a schematic illustration of an optimized W waterfall array, according to some embodiments of the present invention.

FIG. 8 is a schematic illustration of a simple state waterfall implementation in the state section, representing one job being processed in the state section, according to some embodiments of the present invention.

FIG. 9 is a schematic illustration of an exemplary optimized state waterfall array, according to some embodiments of the present invention.

FIG. 10 is a schematic illustration of the waterfall implementations in the data (W) and state sections, according to some embodiments of the present invention; and

FIG. 11 is a schematic flowchart illustrating a method for hash calculation according to some embodiments of the present invention.

The drawings together with the following detailed description make apparent to those skilled in the art how the invention may be embodied in practice.

### DETAILED DESCRIPTION OF THE INVENTION

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

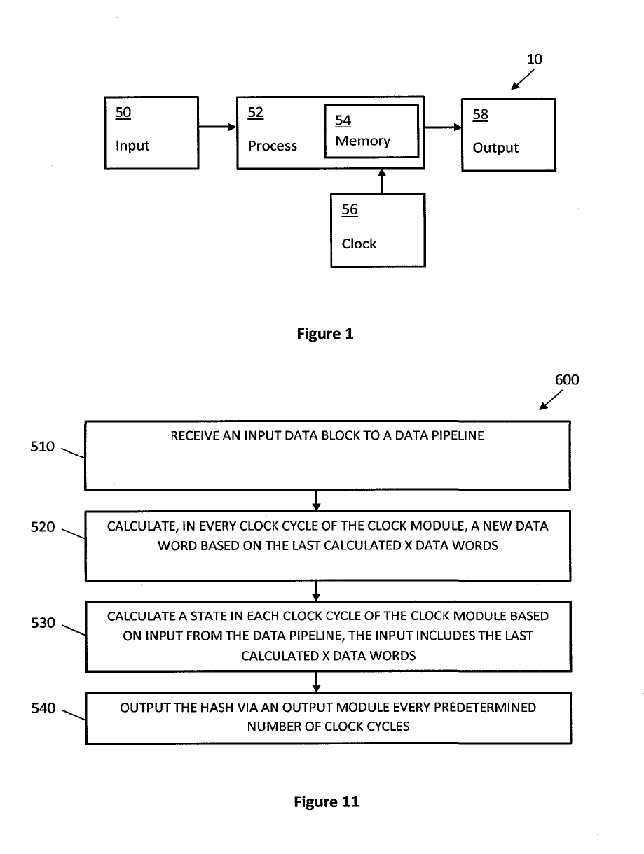

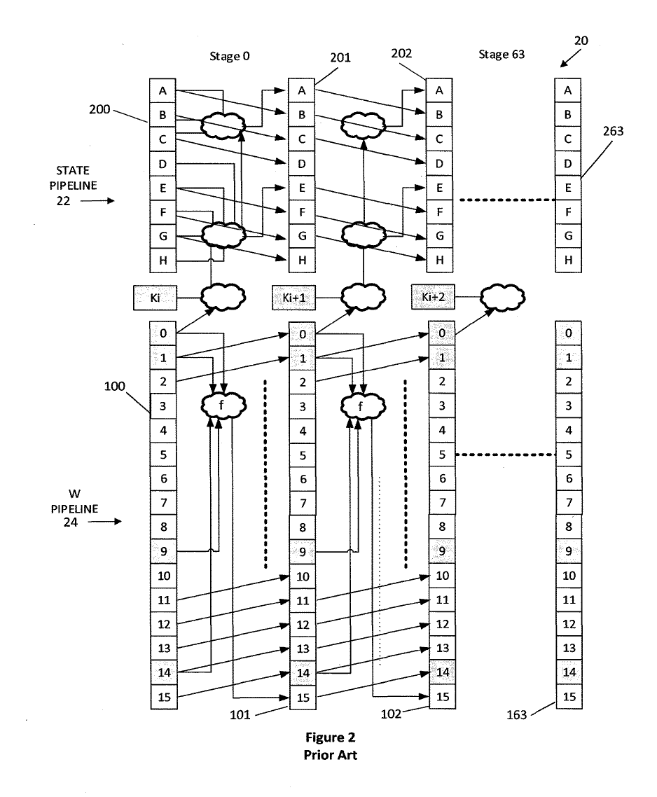

Reference is now made to FIG. 1, which is a schematic illustration of a SHA-256 hash engine 10 in accordance with embodiments of the present invention. Engine 10 includes an input module 50, a process module 52, memory 54, a clock module 56 and an output module 58. As mentioned above, a SHA-256 hash function is used for the signature calculation. In the SHA-256 process, input data block 100 is provided (see more detailed description with reference to FIGS. 2-5) via input module 50. Input data block 100 may be stored in memory 54. Process module 52 may then perform on input data block 100 a SHA-256 hash logic function, which includes an algorithm of 64 repetitive stages, and which produces a signature. The outcome signature may be outputted via output module 58 and/or stored in memory 54. The SHE-256 hash function is performed by a clocked engine, wherein a stage of hash engine 10 is performed in each clock cycle provided by clock module 56.

Reference is now made to FIG. 2, which is a schematic illustration of a state-of-the-art process 20 for signature calculation, also called herein “the regular implementation”. As mentioned above, a SHA-256 hash function is used for the signature calculation. In the SHA-256 process, input data block 100 is provided, and by a repetitive algorithm of 64 stages that are performed based on input data block 100, a signature 263 is produced. The engine is constructed of a state section/pipeline 22 and a data (“W”) section/pipeline 24.

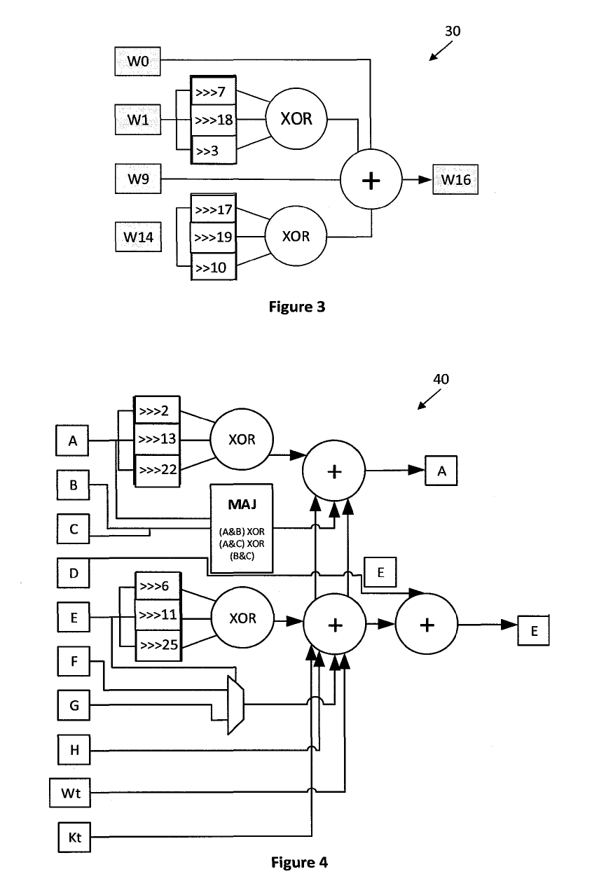

Input data block 100 induces data blocks 101-163, each induced according to a logic algorithm (described in detail with reference to FIG. 3) based on the previous data block. Input data block 100 and each of the induced data blocks 101-163 are 512 bits data blocks, each includes 16 words (“W”s 0-15) of 32 bits. The logic of W pipeline 24 generates an induced data block every stage, by generating a new W15 by a function of words W0, W1, W9 and W14 of the previous data block. That is, W15[i+1]=f (W0[i], W1[i], W9[i], W14[i]). The rest of the words of the induced data block are produced by shifting W1-W15 of the previous block to W0-W14 of the induced block, respectively. Accordingly:

$$\begin{matrix}W 0 [ i + 1 ] = W 1 [ i ] \\ W 1 [ i + 1 ] = W 2 [ i ] \\ ⋮ \\ W 14 [ i + 1 ] = W 15 [ i ]\end{matrix}$$

Input data block 100 is provided to W pipeline 24, which feeds state pipeline 22 with W0 of input data block 100. A first state 200 is produced based on W0 of input data block 100. Each of the following states 201-263 is produced in the respective stage based on the previous state and on the first word, i.e. W0, of the respective induced data block of the respective stage. For example, a state [i] is produced in stage [i] based on state [i−1] and on W0[i] of data block [i]. Stage [i] gets W0 from data block [i], and the following stage [i+1] get W0[i+1] from data block [i+1].

As described in detail herein, embodiments of the present invention enables loading, in each clock cycle, i.e. in each stage, of a new 32 bit word only, rather than copying 16 such words in each cycle. Therefore, the overall power consumption of the Bitcoin mining engine is reduced. Such implementation is called herein “the waterfall implementation”, and it may be applied to the W section 24 as well as to the state section 22.

FIG. 3 is a schematic illustration of a logic circuit 30 representing W15[i+1]=W16[i]=f(W0[i], W1[i], W9[i], W14[i]), i.e. the logic function that is implemented in order to create W15 of an induced data block based on W0, W1, W9 and W14 of the previous data block.

FIG. 4 is a schematic illustration of a logic circuit 40 representing the arithmetic logic that is used for calculating the state words A and E of the next state in the state pipeline. The state words A and E of stage i+1 is calculated by manipulation of W0 and words A-H of the previous stage.

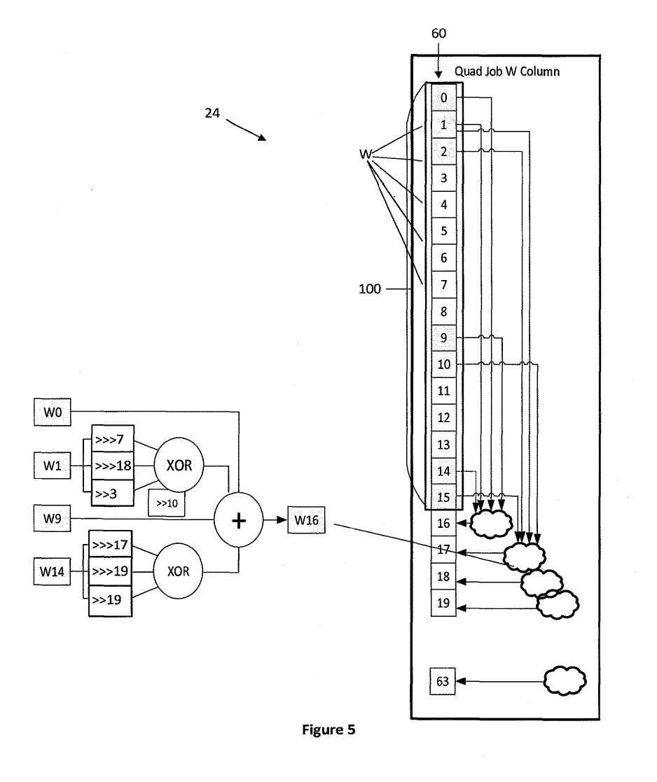

Reference is now made to FIG. 5, which is a schematic diagram illustrating one job being processed in the data (W) section 24 in a simple W waterfall implementation, herein referred to as a W waterfall, according to some embodiments of the present invention. In the waterfall implementation, instead of creating a data block of 16 words in each stage, the data words may be arranged in succession 60. In the implementation of FIG. 5, the words are arranged in one column. On each cycle, a new W is created according to the previous 16 words. As explained in reference to FIG. 3, input data block 100 that includes the first 16 words is provided. The first word W0 is sampled by state section 22 for generation of the first state. The seventeenth word W16 is created based on the first, second, tenth and fourteenth words (W0, W1, W9 and W14), for example as described in detail herein above. On the next cycle, W0 becomes irrelevant and data is taken from W1-W16 instead of W0-W15, respectively, to produce the next word (W17) and the corresponding state in the state section. Then, W1 becomes irrelevant and words W2-W17 are used, and so on. This process is called herein a waterfall process. After 16 cycles the waterfall process continues with words W16-W31 and the first 16 words W0-W15 are irrelevant. At this stage, a new data block 100 of 16 words can enter the W waterfall. Therefore, in this implementation, a new job can enter the W waterfall every 16 cycles. Since only one word of 32 bits changes every cycle, power is saved. In this implementation, however, the performance is 1/16 of the performance of a full pipeline engine, since new data can be received once in every 16 cycles.

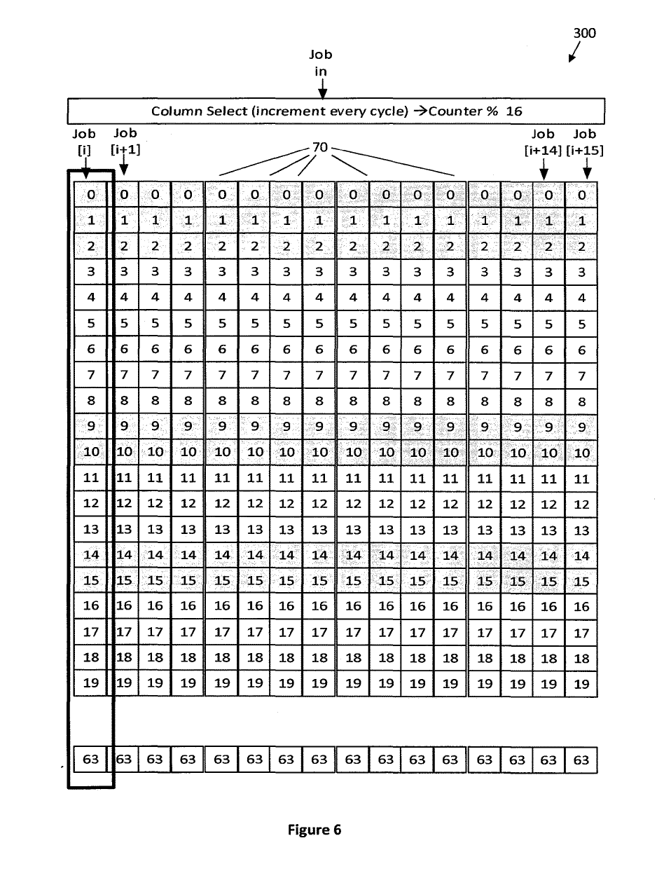

Reference is now made to FIG. 6, which is a schematic illustration of a W waterfall array 300, which allows a new job entry, i.e. new data input, on every cycle, rather than new data every 16 cycles when using one column, according to some embodiments of the present invention. In the W waterfall array implementation, 16 columns 70 of W waterfalls are set in an array format, wherein a new job, i.e. new data input, is entered to another column at each cycle. After sixteen cycles, the first 16 words of the first column are irrelevant, as described in detail above, and a new job can be entered to the first column, taking the place of the first 16 words. In the next cycle, a new job can be entered to the second column, and so on. Accordingly, during every 16 cycles, jobs i to i+15 are entered.

Accordingly, in the efficient W waterfall array implementation of FIG. 6, every column may represent a process where a new job is being entered once in every 16 cycles and occupies the place of words W0-W15 and then for the next 16 cycles the next 16 words are generated and so on. When a job that entered gets to word W63, after 64 cycles, a column maintains four jobs, one in the places of words W0-W15, one in the places of words W16-W31, one in the places of words W32-W47 and one in the places of words W48-W63. In order to provide performance of a new job per cycle instead of job per 16 cycles, 16 columns are used so a new job can be inserted in the place of words W0-W15 of another column in each cycle. When a processed job reaches W63, a signature may be produced and the process of this job ends.

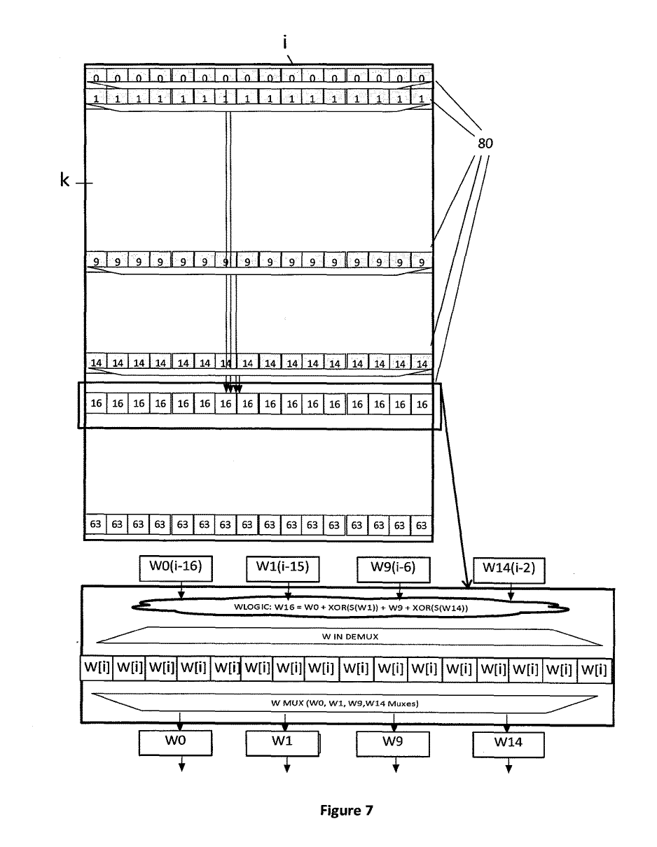

Reference is now made to FIG. 7, which is a schematic illustration of an optimized W waterfall array, according to some embodiments of the present invention. In this implementation, the data words are arranged in rows 80 (row[0]-row[63]), such that the words W0 of all the 16 processed jobs are in row 0 and so on, i.e. the sixteen words W[k]s of the 16 jobs are in row [k]. In each cycle, for each row k in the array, if k>15, an input stage is performed in which a new word W is generated for a selected column i, by receiving a W0 multiplexed value from row k−16, a W1 multiplexed value from row k−15, a W9 multiplexed value from row k−7 and a W14 multiplexed value from row k−2, demultiplexing the multiplexed values in order to feed the relevant values for the selected column i and creating a new word W according to the logic described with reference to FIG. 3. On each cycle, the subsequent column i in row k is selected until the end of row k is reached after 16 cycles and so forth. Additionally, an output stage is performed in which a multiplexed value is generated by multiplexing the words in row k, to be used as W0, W1, W9 and W14 multiplexed values for generating a new word W in each of rows k+16, k+15, k+7 and k+2. The selection and multiplexing may be controlled by a selection and/or control logic which may be included in process module 52. This structure allows insertion of a new job every cycle, each time to a next column.

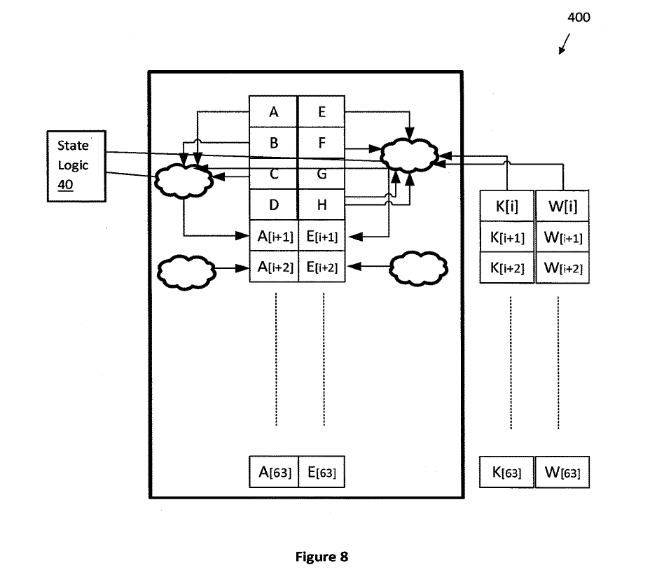

Reference is now made to FIG. 8, which is a schematic illustration of a simple state waterfall implementation 400 in state section 22, representing one job being processed in state section 22, according to some embodiments of the present invention. The state words A, B, C, D, E, F, G and H are generating words A and E of the next state. Since words B, C and D are generated by shift of A to B, B to C and C to D, they are represented as A[i−3], A[i−2], A[i−1], respectively. Similarly, F[i+1], G[i+2] and H[i+3] are generated from E[i]. A and E are generated every new cycle based of the relevant data word from the W section and the older A[i−4] and E[i−4] are not relevant anymore. Therefore, a new job can get into a single-column state waterfall every 4 cycles.

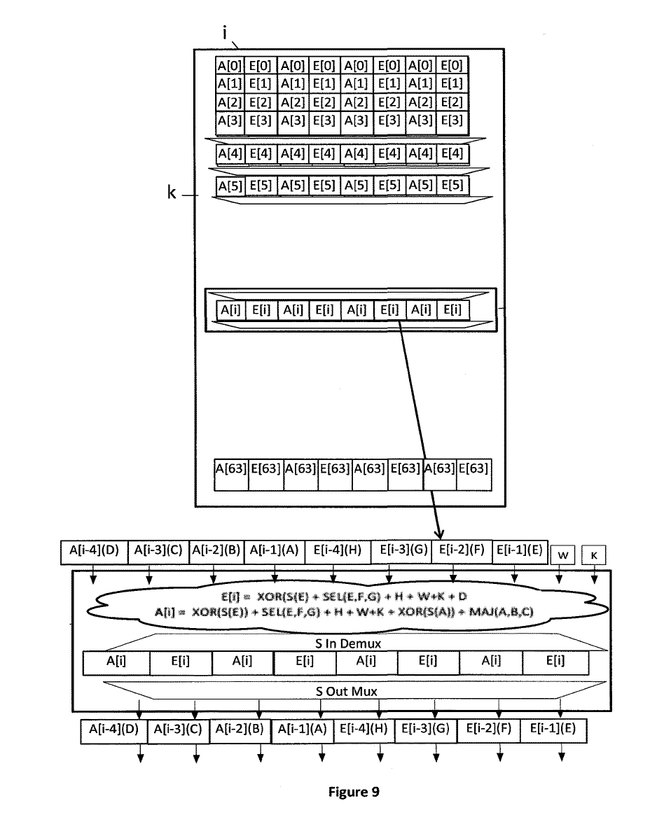

Reference is now made to FIG. 9, which is a schematic illustration of an exemplary optimized state waterfall array, according to some embodiments of the present invention. In this implementation, the state words are structured in rows. Row 0 includes four couples of A[0] and E[0] state words of respective four jobs, in row [k] there are four couples of the A[k] and E[k] state words. This structure allows a job injection every cycle, each time to the next column in the row. In this implementation, the state words are arranged in rows, such that four couples of A[0] and E[0] state words of the four processed jobs are in row 0 and so on, i.e. four couples of A[k] and E[k] state words of the four processed jobs are in row [k]. In each cycle, for each row k in the array, if k>3, an input stage is performed in which new A and E state word are generated for a selected column i that includes a selected job, by receiving multiplexed values of A-K from rows k−1, k−2, k−3 and k−4, i.e. A[k−1] and E[k−1] (A and E), A[k−2] and E[k−2] (B and F), A[k−3] and E[k−3] (C and G) and A[k−4] and E[k−4] (D and H). The A-F values are demultiplexed in order to feed the relevant values for the selected column i and creating new A and E according to the logic described with reference to FIG. 4. On each cycle, the subsequent column i in row k is selected until the end of row k is reached after 4 cycles and so forth. Additionally, an output stage is performed in which a multiplexed value is generated by multiplexing the state words in row k, to be used as A-F multiplexed values for generating new state words A and E in each of rows k+1, k+2, k+3 and k+4. The selection and multiplexing may be controlled by a selection and/or control logic which may be included in process module 52. This structure allows insertion of a new job every cycle, each time to a next column.

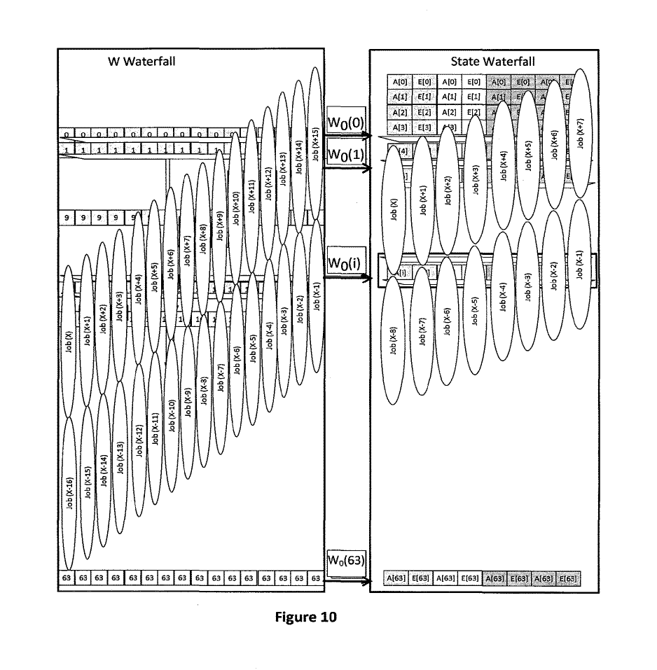

Reference is now made to FIG. 10, which is a schematic illustration of the waterfall implementations in the data (W) and state sections, according to some embodiments of the present invention. As shown in FIG. 10, the waterfall implementations enable a large amount of jobs to be processed concurrently, wherein each job “falls” towards the 64^{th} stage in each cycle, thus allowing a new job to enter, to another column on each cycle.

Reference is now made to FIG. 11, which is a schematic flowchart illustrating a method 600 for hash calculation according to some embodiments of the present invention. As indicated in block 510, the method may include receiving an input data block to a data pipeline, the data block may include a sequence of data words including X data words, wherein X is a known number. For example, the input data block may include 16 words of 32 bits each. As indicated in block 520, the method may include calculating, in every clock cycle of the clock module, a new data word based on the last calculated X data words. As indicated in block 530, the method may include performing a stage of the state pipeline in each clock cycle of the clock module, in which a state is calculated based on input from the data pipeline, the input includes the last calculated X data words. As indicated in block 540, the method may include outputting the hash via an output module every predetermined number of clock cycles.

In some embodiments of the present invention, the calculated state includes a sequence of eight state words, wherein the method further comprises calculating, in each clock cycle, a first and fifth new state words of the sequence, in order to form a new state of sequenced eight words based of the previous state's words

In some embodiments of the present invention, the method may further include inserting, after X clock cycles, a new input data block instead of the first X data words of the previously inserted input data block.

In some embodiments of the present invention, the engine has an array arrangement, the array has X columns to which input data blocks can be inserted, wherein the method further comprises receiving a new input data blocks to another of the X columns on every clock cycle, once the first X data words in the column become irrelevant. Each column may include up to four different input data blocks in process.

In some embodiments of the present invention, the method may further include providing to a row in said array arrangement, in each clock cycle, multiplexed values from previous rows, demultiplexing the multiplexed values in order to create a new data word in a selected column, and generating multiplexed word values by multiplexing data words of the row, for generating new words in following rows.

In some embodiments of the present invention, the engine has an array arrangement in the state pipeline, the array has four columns, to which state sequences can be inserted, each state sequence is represented by four couples of a first and a fifth words, wherein the method further comprises receiving a new state sequence to another of the four columns on every clock cycle, once the first four couples in the column become irrelevant.

In some embodiments of the present invention, the method may further include providing to a row in said array arrangement, in each clock cycle, multiplexed values from previous rows, demultiplexing the multiplexed values in order to create a new state word in a selected column, and generating multiplexed word values by multiplexing state words of the row, for generating new words in following rows.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein.

While the invention has been described with respect to a limited number of embodiments, these should not be construed as limitations on the scope of the invention, but rather as exemplifications of some of the preferred embodiments. Other possible variations, modifications, and applications are also within the scope of the invention.

What is claimed is:

1. A hash engine comprising:
an input module for receiving data blocks;
a memory;
a clock module to provide clock cycles;
a process module including a data pipeline and a state pipeline for calculating a hash from a received data block, the process module is configured to:
receive an input data block to the data pipeline, the data block includes a sequence of data words including X data words, wherein X is a known number;
calculate, in every clock cycle of the clock module, a new data word based on the last calculated X data words; and
perform a stage of the state pipeline in each clock cycle of the clock module, in which a state is calculated based on input from the data pipeline, the input includes the last calculated X data words; and
an output module to output the hash every predetermined number of clock cycles.

2. The engine of claim 1, wherein X is equal 16, and wherein each data word is of 32 bits.

3. The engine of claim 1, wherein the calculated state includes a sequence of eight state words, wherein the process module is further configured to calculate, in each clock cycle, a first and fifth new state words of the sequence, in order to form a new state of sequenced eight words based of the previous state's words.

4. The engine of claim 1, wherein after X clock cycles, a new input data block is inserted instead of the first X data words of the previously inserted input data block.

5. The engine of claim 1, wherein the engine has an array arrangement, the array has X columns to which input data blocks can be inserted, wherein the engine is configured to receive a new input data blocks to another of the X columns on every clock cycle, once the first X data words in the column become irrelevant.

6. The engine of claim 5, wherein each column may include up to four different input data blocks in process.

7. The engine of claim 5, further configured to provide to a row in said array arrangement, in each clock cycle, multiplexed values from previous rows, to demultiplex the multiplexed values in order to create a new data word in a selected column, and to generate multiplexed word values by multiplexing data words of the row, for generating new words in following rows.

8. The engine of claim 3, wherein the engine has an array arrangement in the state pipeline, the array has four columns, to which state sequences can be inserted, each state sequence is represented by four couples of a first and a fifth words, wherein the engine is further configured to receive a new state sequence to another of the four columns on every clock cycle, once the first four couples in the column become irrelevant.

9. The engine of claim 8, further configured to provide to a row in said array arrangement, in each clock cycle, multiplexed values from previous rows, to demultiplex the multiplexed values in order to create a new state word in a selected column, and to generate multiplexed word values by multiplexing state words of the row, for generating new words in following rows.

10. A method for hash calculation, the method comprising:
receiving data blocks via an input module;
providing clock cycles by a clock module;
calculating a hash from a received data block by a process module including a data pipeline and a state pipeline, the hash calculation comprising:
receiving an input data block to the data pipeline, the data block includes a sequence of data words including X data words, wherein X is a known number;
calculating, in every clock cycle of the clock module, a new data word based on the last calculated X data words; and
performing a stage of the state pipeline in each clock cycle of the clock module, in which a state is calculated based on input from the data pipeline, the input includes the last calculated X data words; and
outputting the hash via an output module every predetermined number of clock cycles.

11. The method of claim 10, wherein X is equal 16, and wherein each data word is of 32 bits.

12. The method of claim 10, wherein the calculated state includes a sequence of eight state words, wherein the method further comprises calculating, in each clock cycle, a first and fifth new state words of the sequence, in order to form a new state of sequenced eight words based of the previous state's words.

13. The method of claim 10, further comprising inserting, after X clock cycles, a new input data block instead of the first X data words of the previously inserted input data block.

14. The method of claim 10, wherein the engine has an array arrangement, the array has X columns to which input data blocks can be inserted, wherein the method further comprises receiving a new input data blocks to another of the X columns on every clock cycle, once the first X data words in the column become irrelevant.

15. The method of claim 14, wherein each column may include up to four different input data blocks in process.

16. The method of claim 14, further comprising providing to a row in said array arrangement, in each clock cycle, multiplexed values from previous rows, demultiplexing the multiplexed values in order to create a new data word in a selected column, and generating multiplexed word values by multiplexing data words of the row, for generating new words in following rows.

17. The method of claim 12, wherein the engine has an array arrangement in the state pipeline, the array has four columns, to which state sequences can be inserted, each state sequence is represented by four couples of a first and a fifth words, wherein the method further comprises receiving a new state sequence to another of the four columns on every clock cycle, once the first four couples in the column become irrelevant.

18. The method of claim 17, further comprising providing to a row in said array arrangement, in each clock cycle, multiplexed values from previous rows, demultiplexing the multiplexed values in order to create a new state word in a selected column, and generating multiplexed word values by multiplexing state words of the row, for generating new words in following rows.
